(19) United States
(12) Patent Application Publication
(10) Pub. No.: US 2002/0147738 A1
(43) Pub. Date: Oct. 10, 2002

(54) Method and appratus for finding patent-relevant web documents

(76) Inventor: Scot A. Reader, Sherman Oakes, CA (US)

Correspondence Address: Scot A. Reader, Esq., 3424 Woodcliff Road, Sherman Oakes, CA, 91403, US

(21) Appl. No.: 09/828,649

(22) Filed: Apr. 6, 2001

(51) Int. Cl. G06F 17/21; G06F 17/30

(52) U.S. Cl. 707/500; 707/501.1; 707/5

(57) ABSTRACT

Automated search technique for discovering patent-relevant publications on the Internet. A search client resident on an end-user station initiates linked searches for patent language and Web documents in a manner transparent to a user. From the user's perspective, a patent-identifying attribute, such as an inventor name, assignee name or patent number, input on an end-user station automatically returns Web document identifiers, such as Uniform Resource Locators (URLs). The Web document search may be conducted in a database including Web document summaries or in a database including full-text Web documents.

### BACKGROUND OF THE INVENTION

Patent professionals often search for publications relevant to patents. Searches typically arise in two contexts: when looking for “prior art” publications that might invalidate a patent and when looking for publications that might disclose an infringement of a patent.

An ever-increasing number of publications are being published on the Internet, for example, “white papers” published on companies' public websites. Thus, the Internet has become a more and more important resource for patent professionals looking for publications relevant to patents. However, patent professionals have for the most part relied on general Internet search techniques, such as applying keywords to general-purpose Internet search engines, to discover patent-relevant publications on the Internet.

There is a need for a search technique for discovering patent-relevant publications on the Internet that is more highly automated and better suited the needs of patent professionals.

### SUMMARY OF THE INVENTION

The present invention provides a highly automated search technique for discovering patent-relevant publications on the Internet. The high level of automation may be achieved with the expedient of a search client resident on an end-user station that initiates linked searches for patent data and Internet publication data in a manner transparent to a user. From the user's perspective, a patent-identifying attribute, such as an inventor name, assignee name or patent number, input on an end-user station automatically returns Internet publication data, such as Uniform Resource Locators (URLs) of Web documents. The invention thereby allows a user to find patent-relevant publications on the Internet by merely inputting a patent-identifying attribute. A patent-identifying attribute may be a patent family-identifying attribute, such as an inventor name or assignee name. Or a patent identifying-attribute may be a single patent-identifying attribute, such as a patent number. Or a patent identifying-attribute may be a patent claim-identifying attribute, such as a patent claim number. A basic method for finding patent-relevant documents published on the Internet in accordance with the present invention comprises the steps of: inputting a patent-identifying attribute on an end-user station; identifying patent data from the patent-identifying attribute; identifying Internet publication data from the patent data; and outputting the Internet publication data on the end-user station.

In one embodiment, a search client interacts with a general-purpose search engine to find patent-relevant publications on the Internet. In such embodiment, the linked searches initiated by the search client include a search in a patent database and a search in a Web document database associated with a general-purpose search engine. In such embodiment, the Web document database includes Web document summaries previously prepared by “Web crawler” software.

In a second embodiment, patent-relevant publications are found independent of a general-purpose search engine. In such embodiment, the linked searches initiated by the search client include a search in a patent database and, in conjunction with a search agent, a search in a Web document database hosting a company website. In such embodiment, the Web document database includes full-text Web documents from the company website. The search agent may be co-located with the search client on an end-user station.

These and other aspects of the invention will be better understood by reference to the following detailed description taken in conjunction with the accompanying drawings. Of course, the invention is defined by the appended claims.

### BRIEF DESCRIPTION OF THE DRAWINGS

FIG. 1 shows a communication system illustrative of the present invention in a first embodiment;

FIG. 2 is a flow diagram illustrative of the present invention in a first embodiment;

FIG. 3 shows a communication system illustrative of the present invention in a second embodiment; and

FIG. 4 is a flow diagram illustrative of the present invention in a second embodiment.

### DETAILED DESCRIPTION OF THE PREFERRED EMBODIMENT

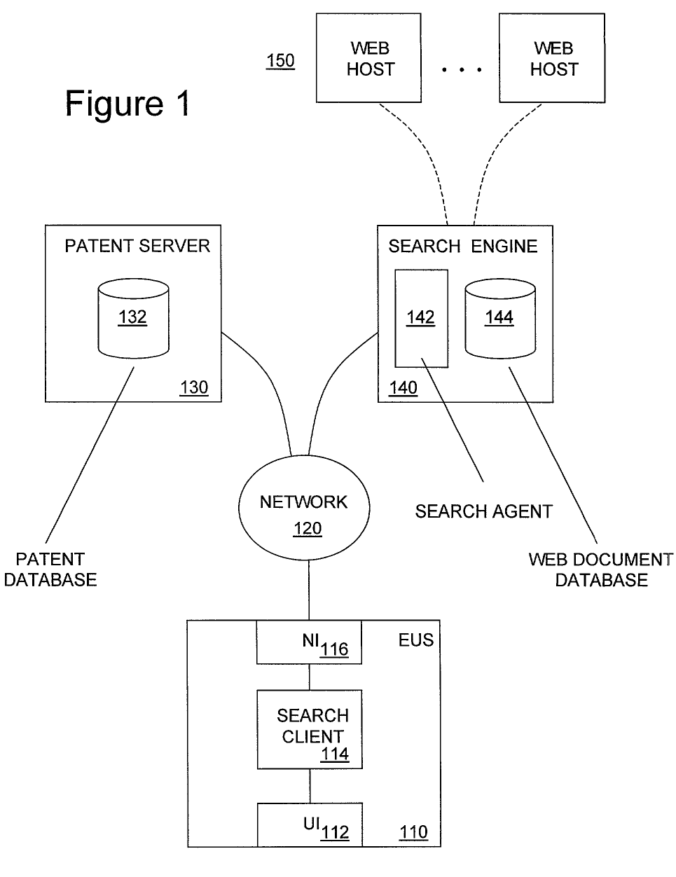

Turning to FIG. 1, a communication system in which the present invention is operative in accordance with a first embodiment is shown. The communication system includes an end-user station (EUS) 110, such as a personal computer or workstation, having a user interface (UI) 112, a processor-implemented search client 114 and a network interface (NI) 116. Search client 114 is a software application. End-user station 110 has access to patent server 130 and search engine 140 via network 120. Network 120 may include local area networks (LANs) and wide area networks (WANs). That is, end-user station 110 may have access to patent server 130 and search engine 140 via any combination of LANs and WANs. Patent server 130 has patent database 132 thereon. Patent database 132 has entries stored thereon associating patent-identifying attributes, such as inventor names, assignee names and patent numbers, with patent language, such as patent claim text. Entries may include full-text patents. Search engine 140 has search agent 142, which may be processor-implemented, and Web document database 144. Search agent 142 is a “Web crawler” software application that automatically visits Web hosts 150, which are “Web hosting” servers hosting the websites of companies, extracts Web document summaries from Web documents encountered thereon, and creates entries in Web document database 144 associating such Web document summaries with the URLs of the Web documents from which the summaries were extracted. Web hosts 150 are addressable by search engine 140 through Domain Name Service (DNS) or Internet Protocol (IP) addressing schemes well known in the art. Similarly, patent server 130 and search engine 140 are addressable by end-user station 110 through DNS or IP addressing schemes well known in the art.

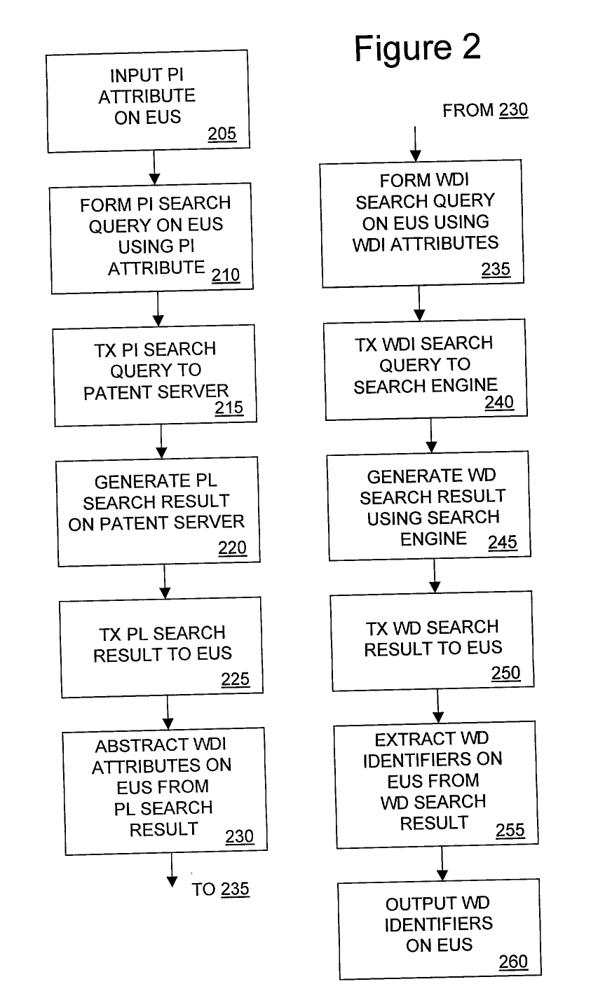

Fundamental to achievement of a high level of automation in locating patent-relevant publications on the Internet in accordance with the present invention is the search client. In a first embodiment, search client 114, in response to an input by a user on user interface 112 that may include one or more patent-identifying attributes, takes a series of actions transparent to the user, including initiating linked searches on patent server 130 and search engine 140, to reveal Internet publications relevant to the patent-identifying attributes. Turning now to FIG. 2, operation of search client 114 within the communication system shown in FIG. 1 to achieve such transparent functionality is described in even greater detail by reference to a flow diagram. A user of end-user station 110 inputs at least one patent-identifying (PI) attribute on user interface 112 (205). Patent-identifying attributes may include, by way of example, inventor names, assignee names and patent numbers. If a patent number is input as a patent-identifying attribute, it may be desirable to input as a second patent-identifying attribute a patent claim number. By way of example, a user desiring to discover Internet publications relevant to any patent assigned to corporation X may input the single patent-identifying attribute “assignee=corporation X”. A user desiring to discover Internet publications relevant to claim 1 of U.S. Pat. No. Y may input the plurality of patent-identifying attributes “patent=Y” and “claim=1”. Search client 114 forms a patent-identifying search query using the one or more patent-identifying attributes (210). In this regard, search client 114 forms a search query targeted, when applied to patent database 132, to retrieve a patent language search result that includes language from one or more patents that is relevant to the patent-identifying attributes. Relevancy may be expressed in relation to a matching of a patent-identifying attribute with data stored in a corresponding field of an entry within patent database 132. Thus, continuing the second example from above, search client 114 may form a search query that, when applied to patent database 132, would retrieve language from U.S. Pat. No. Y as a result of a match of the patent-identifying attribute element “Y” (from the attribute “patent=Y”) with the number “Y” stored in the patent number field of the entry for U.S. Pat. No. Y within patent database 132. The patent-identifying search query is transmitted via network interface 116 and network 120 from end-user station 110 to patent server 130 (215). Patent server 130 applies the patent-identifying search query to patent database 132 to generate a patent language (PL) search result (220). Continuing the second example from above, the patent language search result would include the text of claim 1 of U.S. Pat. No. Y. The patent language search result is transmitted via network 120 from patent server 130 to end-user station 110 (225). Search client 114 abstracts Web document-identifying (WDI) attributes from the patent language search result (230) and forms a Web document-identifying search query using the attributes (235). In this regard, search client 114 forms a search query targeted, when applied on search engine 140, to retrieve a Web document search result that includes Web document identifiers, such as URLs, of Web documents having Web document summaries relevant to the Web document-identifying attributes. Relevancy may be expressed in relation to the quality of a match of the Web document-identifying attributes with the Web document summaries stored in entries within Web document database 144. Abstraction of Web document-identifying attributes from the patent language search result may be accomplished by any of numerous algorithms well known in the art. Abstraction may involve, for example, reduction of a full-text patent claim to keywords separated by Boolean operators, which keywords and operators may be selected taking into account the syntactic and lexico-semantic interdependency of the words (i.e. context) of the full-text claim. Alternatively, for a search engine capable of “natural language” searching, minimal or no abstraction may be required. In any case, the Web document-identifying search query is transmitted via network interface 116 and network 120 from end-user station 110 to search engine 140 (240). Search engine 140 applies the Web document-identifying search query to Web document database 144 to generate a Web document (WD) search result (245). The Web document search result is transmitted via network 120 from search engine 140 to end-user station 110 (250). Search client 114 extracts Web document identifiers from the Web document search result (255) and outputs the Web document identifiers (260) on user interface 112. Of course, if there is more than one patent or patent claim identified in response to a patent-identifying attribute, steps 220 through 260 might be repeated for each identified claim (or independent claim) of each identified patent, resulting in the discovery of relevant Web documents for each such claim (or independent claim) of each such patent. Therefore, the present invention may radically improve automation over conventional Internet search techniques by returning to a user Web document identifiers individually tailored for each of a plurality of attribute-related patents (e.g. each patent assigned to company X) and/or patent claims (e.g. each independent claims in U.S. Pat. No. Y) in response to input of a single patent-identifying attribute.

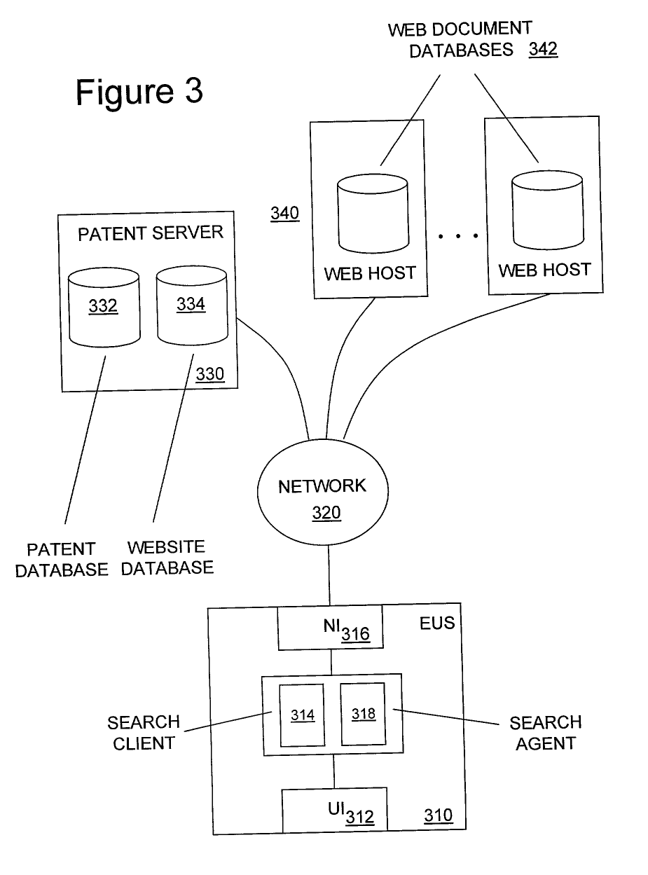

Turning now to FIG. 3, a communication system in which the present invention is operative in accordance with a second embodiment is shown. The communication system includes an end-user station (EUS) 310, such as a personal computer or workstation, having a user interface (UI) 312, a processor-implemented search client 314 and search agent 318 and a network interface (NI) 316. Search client 314 and search agent 318 are software applications. End-user station 310 has access to patent server 330 and Web hosts 340 via network 320 that may include local area networks (LANs) and wide area networks (WANs). Patent server 330 has patent database 332 and website database 334 resident thereon. Patent database 332 has entries stored thereon associating patent-identifying attributes, such as inventor names, assignee names and patent numbers, with patent classifications and patent language, such as patent claim text. Entries may include full-text patents. Website database 334 has entries stored thereon associating patent classifications with company website identifiers, such as URLs of company home pages. In this regard, website database 334 may have entries for various companies associating the home page URLs of such companies with patent classifications in which such companies hold patents. Web hosts 340 are “Web hosting” servers hosting company websites addressable using DNS or IP addressing schemes well known in the art. Resident on Web hosts 340 are respective Web document databases 342 having stored thereon full-text Web documents associated with company websites. Patent server 330 is also addressable by end-user station 310 using DNS or IP addressing schemes well known in the art.

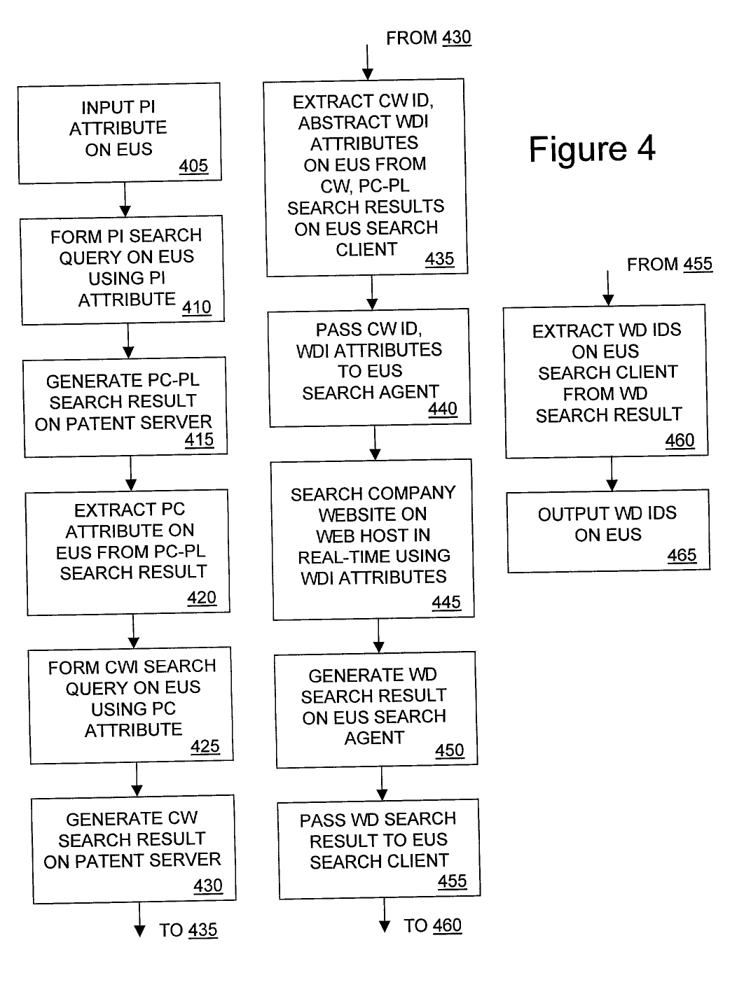

In a second embodiment, search client 314, in response to an input by a user on user interface 312 that includes one or more patent-identifying attributes, takes a series of actions transparent to the user, including initiating linked searches on patent server 330 and, in conjunction with search agent 318, on Web hosts 340, to reveal Internet publications relevant to the patent-identifying attributes. Turning now to FIG. 4, operation of search client 314 and search agent 318 within the communication system shown in FIG. 3 to achieve such transparent functionality is described in even greater detail by reference to a flow diagram, wherefrom some transmission steps have been omitted for simplicity. A user of end-user station 310 inputs at least one patent-identifying (PI) attribute on user interface 312 (405). Search client 314 forms a patent-identifying search query using the one or more patent-identifying attributes (410). In this regard, search client 314 forms a search query targeted, when applied to patent database 332, to retrieve a patent classification/patent language search result that includes pairs of patent classifications and patent language from one or more patents relevant to the one or more patent-identifying attributes. The patent classification may be a U.S. or international patent classification. The patent-identifying search query is transmitted via network interface 316 and network 320 from end-user station 310 to patent server 330. Patent server 330 applies the patent-identifying search query to patent database 332 to generate patent classification/patent language (PC-PL) search result (415). Patent server 330 transmits the patent classification/patent language search result to end-user station 310. End-user station 310, particularly search client 314, extracts a patent classification attribute (PC) attribute from the patent classification portion of the PC-PL search result (420) and forms a company website-identifying (CWI) search query using the patent classification attribute (425). In this regard, end-user station 310 forms a search query targeted, when applied on patent server 330, to retrieve a company website search result that includes one or more company website identifiers, such as URLs of company home pages, relevant to the patent classification attribute. End-user station 310 transmits the CWI search query to patent server 330. Patent server 330 applies the CWI search query to website database 334 to generate company website (CW) search result (430). The CW search result is transmitted to end-user station 310. Search client 314 extracts a company website identifier from the CW search result and abstracts Web document-identifying (WDI) attributes from the patent language portion of the PC-PL search result (435). Search client 314 passes the company website identifier and WDI attributes to search agent 318 (440). Using the company website identifier and well known DNS addressing, search agent 318 contacts the appropriate one of Web hosts 340 and, using well known “Web crawler” techniques, searches the totality of full-text documents published on the associated company website for Web document language relevant to the WDI attributes (445). Upon completion of the search, search agent 318 generates a Web document (WD) search result including Web document identifiers, such as URLs, of the relevant Web documents (450). Search agent 318 passes the Web document search result to search client 314 (455). Search client 314 extracts Web document identifiers from the Web document search result (460) and outputs the Web document identifiers on user interface 312. It will be appreciated that the second embodiment described herein has an advantage in that the relevancy of the Internet publications identified is not limited by the quality of the Web document summaries generated by a general-purpose search engine.

It will be appreciated by those of ordinary skill in the art that the invention can be embodied in other specific forms without departing from the spirit or essential character hereof. The present invention is therefore considered in all respects illustrative and not restrictive. The scope of the invention is indicated by the appended claims, and all changes that come within the meaning and range of equivalents thereof are intended to be embraced therein.

I claim:

1. A method for finding patent-relevant documents published on the Internet, comprising the steps of:
inputting a patent-identifying attribute on an end-user station;
identifying patent data from the patent-identifying attribute;
identifying Internet publication data from the patent data; and
outputting the Internet publication data on the end-user station.

2. The method according to claim 1, wherein the patent data are abstracted prior to identifying the Internet publication data.

3. The method according to claim 1, wherein the sole patent-identifying attribute is an assignee name.

4. The method according to claim 1, wherein the sole patent-identifying attribute is an inventor name.

5. The method according to claim 1, wherein the one or more patent-identifying attributes include a patent number.

6. The method according to claim 1, wherein the Internet publication data include a Uniform Resource Locator (URL).

7. A method for locating a plurality of documents published on the Internet relevant to a plurality of attribute-related patents, respectively, comprising the steps of:
inputting a patent-identifying attribute on an end-user station;
identifying patent data for a plurality of patents from the patent-identifying attribute;
identifying Internet publication data for the plurality of patents from the patent data; and
outputting the Internet publication data on the end-user station.

8. The method according to claim 7, wherein the sole patent-identifying attribute is an assignee name.

9. The method according to claim 7, wherein the sole patent-identifying attribute is an inventor name.

10. The method according to claim 7, wherein the Internet publication data include a plurality of URLs.

11. A method for finding a patent-relevant document published on the Internet, comprising:
accepting as a computer input a patent-identifying attribute;
searching a first database using the patent-identifying attribute to locate patent data;
searching a second database using the patent data to locate Web document data; and
returning as a computer output the Web document data.

12. The method according to claim 11, wherein the sole patent-identifying attribute is an assignee name.

13. The method according to claim 11, wherein the sole patent-identifying attribute is an inventor name.

14. The method according to claim 11, wherein the sole patent-identifying attribute is a patent number.

15. The method according to claim 11, wherein the patent-identifying attributes include a patent number and a patent claim number.

16. The method according to claim 11, wherein the patent data include patent claim language.

17. The method according to claim 11, wherein the Web document data include a URL.

18. A system for locating an Internet publication relevant to a patent, comprising:
a computer for accepting an input and returning an output; and
a plurality of databases;
wherein in response to a patent-identifying attribute accepted as an input the computer initiates searches in the plurality of databases in seriatim to generate Internet publication data returned as an output.

19. The system according to claim 18, wherein the plurality of databases include a patent database and a Web document database.

20. The system according to claim 18, wherein the searches in seriatim include a first search in a patent database and a second search in a Web document database.

21. The system according to claim 20, wherein the Web document database includes Web document summaries.

22. The system according to claim 20, wherein the Web document database includes full-text Web documents.

23. A system for finding an Internet publication relevant to a patent, comprising:
a network; and
a computer having a user interface, for interacting with a user, and a network interface, for interacting with the network;
wherein in response to a patent-identifying attribute Input on the user interface the computer interacts with the network transparent to the user to find a location of an Internet publication relevant to patent language identified from the patent-identifying attribute and to output the location on the user interface.

24. The system according to claim 23, wherein the interaction with the network includes a first search in a patent database and a second search in a Web document database.

25. The system according to claim 23, wherein the interaction with the network includes a first search to identify the patent language and a second search to find the location.

26. The system according to claim 23, wherein the patent language includes patent claim language.

27. The system according to claim 23, wherein the location is a URL.
